(19) United States
(12) Patent Application Publication
(10) Pub. No.: US 2022/0258634 A1
(43) Pub. Date: Aug. 18, 2022

(54) CHARGING CONTROL METHOD FOR ELECTRIC MOVING BODY, AND ELECTRIC MOVING BODY

(71) Applicant: HONDA MOTOR CO., LTD., TOKYO (JP)

(72) Inventor: Hiroto OKABE, TOKYO (JP)

(21) Appl. No.: 17/591,256

(22) Filed: Feb. 2, 2022

(30) Foreign Application Priority Data
Feb. 15, 2021 (JP) 2021-021910

(51) Int. Cl. B60L 53/62; B60L 53/30; H02J 7/00

(52) U.S. Cl. CPC B60L 53/62; H02J 7/005; H02J 7/0048; B60L 53/30

(57) ABSTRACT

A charging control method of an electric moving body that moves using a battery as a power source. A target remaining capacity is set through a user when initial charging of the battery is performed, and the target remaining capacity is set in a manner to decrease every time the battery is charged, based on a usage situation of the battery of the electric moving body by the user.

### CROSS-REFERENCE TO RELATED APPLICATIONS

This application is based upon and claims the benefit of priority from Japanese Patent Application No. 2021-021910 filed on Feb. 15, 2021, the contents of which are incorporated herein by reference.

### BACKGROUND OF THE INVENTION

### Field of the Invention

The present invention relates to a charging control method for an electric moving body such as a vehicle, ship, boat, airplane, or unmanned flying body that moves using a battery loaded therein as a power source, and also to an electric moving body.

### Description of the Related Art

As an example, JP 2013-090360 A discloses a charging control apparatus that determines, as a specified remaining capacity, a target remaining capacity for the time when charging a battery loaded in an electric automobile. This specified remaining capacity is a remaining capacity whereby, after the following trip, the remaining capacity of the battery does not enter a deep discharge region in which deterioration of the battery is promoted.

With the charging control apparatus, this target remaining capacity is determined based on the current remaining capacity of the battery and the necessary power consumption according to information about the following trip.

Furthermore, this charging control apparatus determines a charge amount (target charge amount) from the current remaining capacity to the target remaining capacity (claim 1, claim 3, and paragraph 0023 of JP 2013-090360 A).

### SUMMARY OF THE INVENTION

With the charging control apparatus disclosed in JP 2013-090360 A, it is possible to prevent the battery from experiencing deep discharge while also ensuring the remaining capacity necessary for the following trip.

However, there are cases where the user sees the remaining capacity display (SOC value [%] or the like) of the battery while actually using the electric automobile and feels worried that the displayed remaining capacity is insufficient, or in other words, feels anxious that the power will run out.

In such a case, there is a concern that the user will increase the charging amount beyond what is necessary or revoke the setting for the target remaining capacity made by the charging control apparatus.

The present invention has been devised taking into consideration the aforementioned problem, and has the object of providing an electric moving body and a charging control method for an electric moving body capable of preventing the revocation of settings for the target remaining capacity and improving usability while eliminating worry about insufficiency of the remaining capacity felt by the user and of restricting deterioration of the battery.

A charging control method for an electric moving body according to one aspect of the present invention is a charging control method of an electric moving body that moves using a battery as a power source, including: setting a target remaining capacity through a user when initial charging of the battery is performed; and setting the target remaining capacity in a manner to decrease every time the battery is charged, based on a usage situation of the battery of the electric moving body by the user.

An electric moving body according to another aspect of the present invention is an electric moving body including a charging control apparatus of the electric moving body that moves using a battery as a power source, wherein: the charging control apparatus includes a memory that stores a program and a CPU that reads the program from the memory and executes the program; the CPU executing the program causes the charging control apparatus to set a target remaining capacity through a user when initial charging of the battery is performed; and to set the target remaining capacity to decrease every time the battery is charged, based on a usage situation of the battery of the electric moving body by the user.

According to this invention, the target remaining capacity is set through the user when the battery of the electric moving body is initially charged, and from this time onward the target remaining capacity is set in a manner to decrease every time charging is repeated during a first charging and a second charging, based on the usage situation of the battery of the electric moving body by the user.

In this way, it is possible to prevent the revocation of settings for the target remaining capacity while eliminating worry about insufficiency of the remaining capacity felt by the user and to avoid an overcharge state and restrict deterioration of the battery.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a system diagram showing a configurational example of a system including an electric vehicle as the electric moving body according to an embodiment implementing the charging control method for an electric moving body according to the present embodiment;

FIG. 2 is a block diagram showing a detailed configurational example of the navigation apparatus;

FIG. 3 is a tie chart for describing communication with the user;

FIG. 4 is a flow chart (1/2) provided to describe the operation of the present embodiment;

FIG. 5 is a flow chart (2/2) provided to describe the operation of the present embodiment;

FIG. 6 is a descriptive diagram of a deterioration influence characteristic of the battery according to the present embodiment;

FIG. 7 is a descriptive diagram of a judgment concerning the target remaining capacity reduction announcement;

FIG. 8 is a system diagram showing a configuration of a system according to a first embodiment, in which the charging control apparatus is implemented in a management server on the Internet;

FIG. 9 is another descriptive diagram of a judgment concerning the target remaining capacity reduction announcement according to a second modification; and

FIG. 10 is a descriptive diagram of a deterioration influence characteristic of the battery according to a third modification.

### DESCRIPTION OF THE INVENTION

Preferred embodiments of a charging method for an electric moving body and an electric moving body according to the present invention will be presented and described below with reference to the accompanying drawings.

### [Configuration]

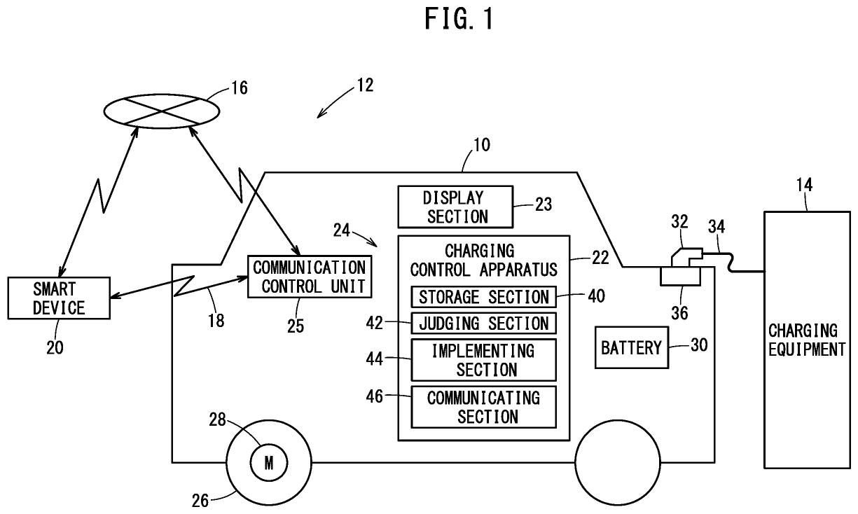

FIG. 1 is a system diagram showing a configurational example of a system 12 including an electric vehicle (here, an electric automobile) 10 as the electric moving body according to an embodiment implementing the charging control method for an electric moving body according to the present embodiment.

The system 12 is formed by, in addition to the electric vehicle 10, charging equipment 14 that supplies power to the electric vehicle 10 from the outside and a smart device 20. The smart device 20 is a smartphone or the like capable of communicating with the electric vehicle 10 via a communication network 16 such as a mobile communication network or short-range wireless communication 18 such as Bluetooth (Registered Trademark). The communication network 16 may include the Internet.

The smart device 20 is a terminal carried by the user who is a driver or the like of the electric vehicle 10.

The electric vehicle 10 includes a navigation apparatus 24, in which the charging control apparatus 22 is implemented, and a battery 30 that supplies power to an electric motor 28 that rotationally drives wheels 26 of the electric vehicle 10.

The battery 30 is a high-capacity lithium-ion battery. The electric vehicle 10 can ensure a cruising distance of approximately 500 [km] with a single charge. The present invention is also capable of being applied to a moving body such as an electric vehicle that has a cruising distance shorter or longer than 500 [km].

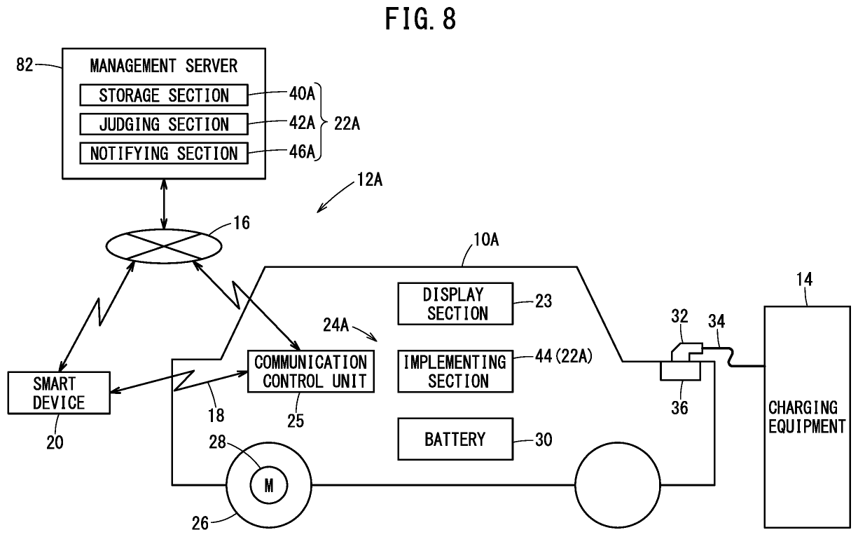

In this electric vehicle 10, the charging control apparatus 22 is implemented in the navigation apparatus 24. The charging control apparatus 22 can also be provided independently from the navigation apparatus 24. In such a case, all configurational elements, or configurational elements other than an implementing section 44 that implements the charging control for power from the charging equipment 14 to the battery 30, can be provided in a management server 82 (FIG. 8) described further below as a first modification, for example.

Returning to FIG. 1, the navigation apparatus 24 includes the charging control apparatus 22, a display section (on-board display) 23, and a communication control unit 25.

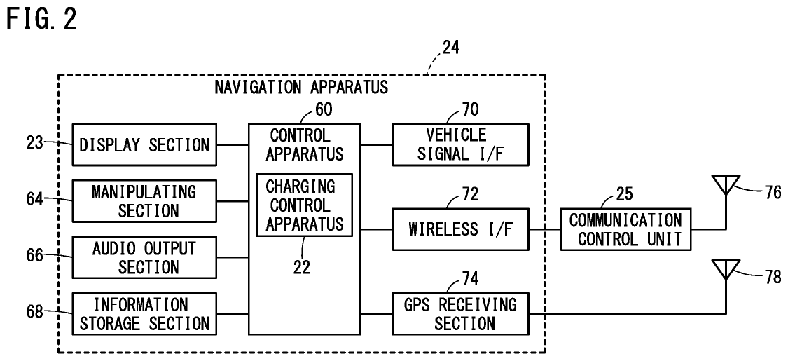

FIG. 2 is a block diagram showing a detailed configurational example of the navigation apparatus 24.

As shown in FIG. 2, the navigation apparatus 24 includes a control apparatus 60 by which the charging control apparatus 22 is implemented. The navigation apparatus 24 includes the display section (display) 23, a manipulating section 64, an audio output section (speaker) 66, an information storage section 68, a wireless I/F 70, a wireless I/F 72, and a GPS receiving section (satellite positioning apparatus) 74, which transmit and receive various signals including a control signal to and from the control apparatus 60.

The display section 23 displays a map, a current location, and a recommended route from the current location to a destination, based on data from the control apparatus 60. The manipulating section 64 is manipulated by the user when the user outputs various instructions to the navigation apparatus 24. The display section 23 and manipulating section 64 may be combined and used as a single touch panel display. The audio output section 66 outputs audio relating to route guidance, various types of notification information, and the like. The information storage section 68 stores data such as map data. The wireless I/F 70 contributes to signal transmission and reception between the control apparatus 60 and sensors (not shown in the drawing), such as a vehicle velocity sensor that detect information relating to the current geographical position and the like.

The wireless I/F 72 contributes to signal transmission and reception between the control apparatus 60 and the communication control unit 25. The communication control unit 25 transmits and receives radio waves via an antenna 76 to communicate with the smart device 20 via the communication network 16 or the short-range wireless communication 18. The GPS receiving section 74 captures GPS radio waves from a positioning satellite with an antenna 78, and identifies the position of the current location based on these GPS radio waves.

The smart device 20 is carried by the user and is capable of, whether the smart device 20 is inside or outside of the electric vehicle 10, communicating with the charging control apparatus 22 of the electric vehicle 10, through wireless communication via the communication network 16 or the short-range wireless communication 18.

The navigation apparatus 24 is capable of communicating with a management server 82 described further below, a server of a power supplier (not shown in the drawings), and the like, via the communication network 16. The management server 82 is capable of communicating with the power supplier through the Internet.

The charging equipment 14, which is connected to a grid power supply (not shown in the drawings) of the power supplier, is installed at a home parking space (prescribed parking location) or workplace parking space (prescribed parking location) of the user of the electric vehicle 10, a charging stand along a public road, or the like. The charging equipment 14 includes a charging cord 34 that has a charging plug (charging gun) 32 provided at the tip thereof.

In a case where the user has judged that the remaining capacity of the battery 30 is low after finishing one day of using the electric vehicle 10 and returning to the prescribed parking location, the user opens a charging lid (not shown in the drawings) of a hood of the electric vehicle 10 when charging is to be performed from the evening. The, with one end of the charging cord 34 connected to the charging equipment 14, the charging plug 32 on the other end thereof is held, removed from a home position (storage position) in the charging equipment 14, and attached to a charging port (connector) 36 of the electric vehicle 10. Due to this, the charging equipment 14 and the charging port 36 are electrically connected to be in a state where charging via the charging cord 34 is possible.

In this case, under the control of the charging control apparatus 22, the battery 30 is charged from the charging equipment 14 during a late-night time period when the electricity price (power price) is usually lower than during the day. If this charging is insufficient, the battery 30 is charged from the charging equipment 14 during the day time when the electricity price is relatively high.

Just because the electric vehicle 10 is connected to the charging equipment 14 via the charging cord 34 does not mean that the battery 30 is being charged.

The charging plan for charging or not charging the battery 30 is determined by a judging section 42 of the charging control apparatus 22, and there may be cases where the charging control apparatus 22 stops or suspends the charging of the battery 30 even when the electric vehicle 10 is connected to the charging equipment 14.

When departing on the following day after the charging has finished, the user removes the charging plug 32 from the charging port 36 and closes the charging lid (not shown in the drawings). After this, the user attaches the charging plug 32 at the home position on the charging equipment 14.

The charging control apparatus 22 is formed by a microcomputer that functions as the various functional sections by having a central processing unit (CPU) execute a program stored in a memory. The charging control apparatus 22 includes, in addition to the storage section 40 that is the memory, the judging section 42 serving as a computing section, an implementing section 44, and a notifying section 46.

The charging control apparatus 22 controls charging of the battery 30 (charging implemented based on the charging plan) when the charging plug 32 of the charging equipment 14 is connected to the charging port 36 of the electric vehicle 10.

Under prescribed conditions, the notifying section 46 provides notification, such as prompting the setting of a target SOC (State Of Charge) [%] that is the target remaining capacity of the battery 30, to the smart device 20 of the user through the communication control unit 25. The notification such as prompting the setting of the target SOC of the battery 30 is also provided to the on-board display section 23.

The remaining capacity is not limited to being the SOC [%], and may instead be a power amount [Wh] or ampere hours [Ah]. The same is true below.

In addition to providing notification prompting the setting of the target SOC of the battery 30 to the smart device 20, the notifying section 46 also provides notification prompting the charging of the battery 30 (“CHARGING REQUIRED”).

These notifications are performed through the short-range wireless communication 18 if the smart device 20 is located in the effective communication area of the short-range wireless communication 18, and performed through the communication network 16 if the smart device 20 is located outside of such a location.

Upon receiving a notification such as the prompting of the setting of the target SOC from the smart device 20 through the notifying section 46, the judging section 42 of the electric vehicle 10 updates the setting value of the target SOC in the program stored in the storage section 40.

Furthermore, upon receiving instructions that charging of the battery 30 is necessary from the judging section 42, the implementing section 44 of the electric vehicle 10 charges the battery 30 to the remaining capacity (target SOC) indicated in the instructions from the judging section 42, in a state where charging is possible.

### [Operation]

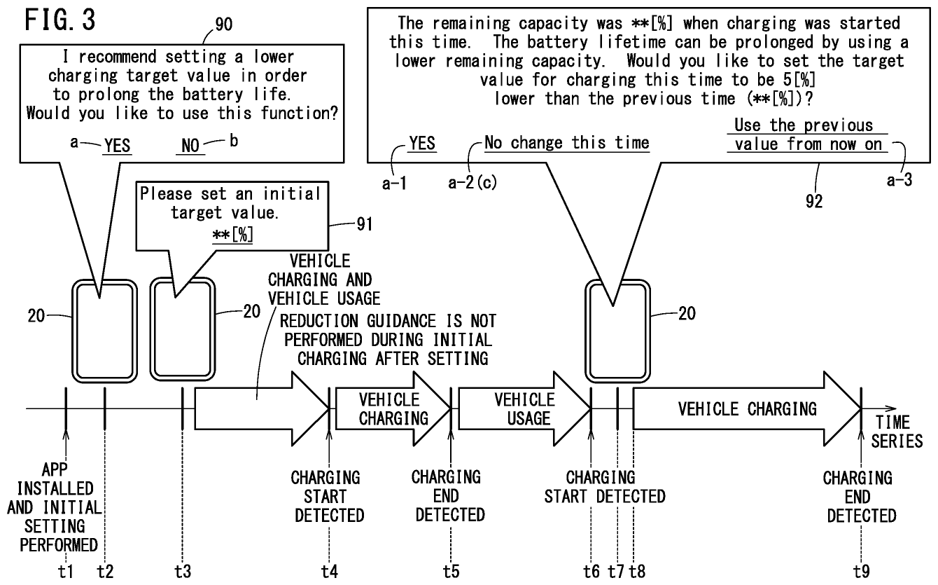

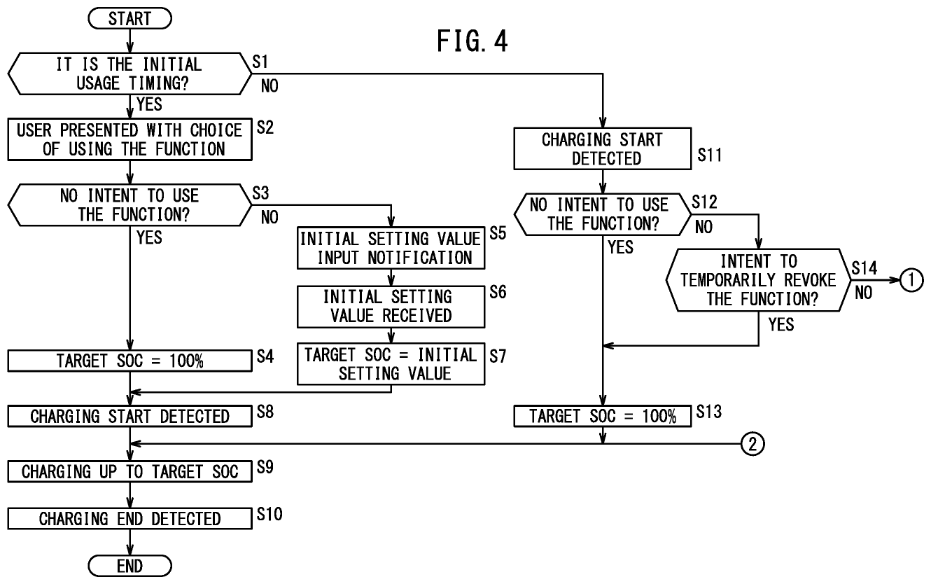

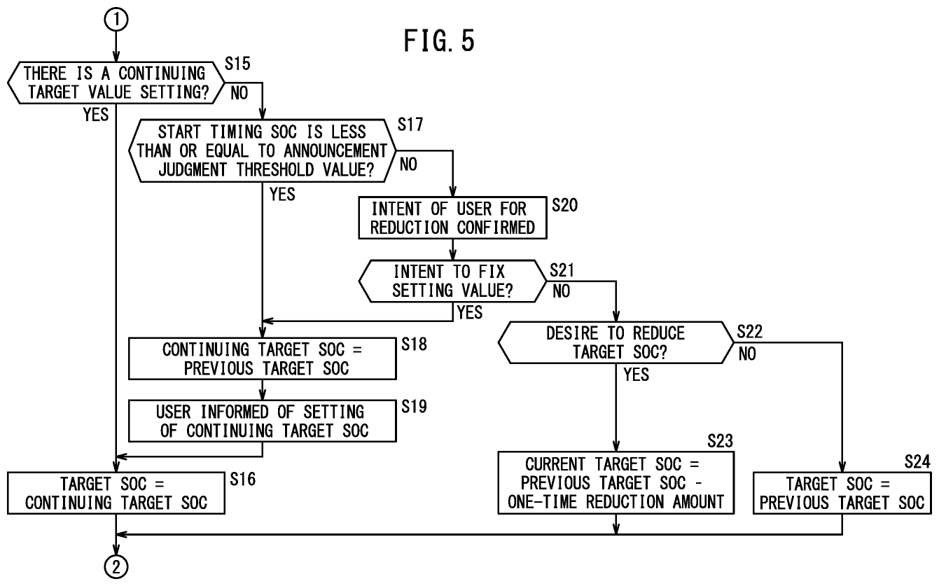

An outline of the operation performed by the (CPU of the) charging control apparatus 22 of the system 12 configured basically as described above is described while referencing FIG. 3, and then details of the operation are described while referencing FIGS. 4 and 5.

### [Outline of the Operation]

Since the target SOC is not be reduced against the intent of the user, the charging control apparatus 22 attempts to communicate with the user through the smart device 20 or navigation apparatus 24 as described below.

An application (APP) for a charging control operation and an application of a notification system having a target SOC reducing function (SOC upper-limit limiting function) are installed in the smart device 20 and the navigation apparatus 24.

In other words, the charging control apparatus 22 implements communication with the user.

The charging control apparatus 22 of the navigation apparatus 24 in which the application of the notification system having the target SOC reducing function (SOC upper-limit limiting function) is installed communicates with the user through the smart device 20 in which the application is installed or through the display section 23 and the audio output section 66 of the navigation apparatus 24.

The following six options (Option a, Option a-1, Option a-2, Option a-3, Option b, and Option c) for the communication to be provided are prepared in advance.

Option a: Using the target SOC reducing function (SOC upper-limit limiting function), that is, using the notification system to notify the user that the target SOC is to be lowered.

Option a-1: Use (YES). In other words, use the target SOC reducing function and agree to the reduction amount of the system.

Option a-2: Do not change this time. In other words, use the target SOC reducing function but do not agree to the reduction amount of the system this time (disagreement).

Option a-3: Use the previously set target SOC as a continuing target SOC.

Option b: Do not use. In other words, do not use the target SOC reducing function.

Option c: Use the target SOC reducing function, but stop the target SOC reducing function just for the current charging.

Here, implementation of the communication with the user regarding the above options (a, a-1, a-2, a-3, b, and c) is described in time series, with reference to the time chart of FIG. 3.

At the timing t1, the application (APP) is installed in the smart device 20, and an initial setting is performed.

Next, at the timing t2, when communication with the user is performed for the first time, the user is presented with Option a (YES) and Option b (NO), via the smart device 20 or the navigation apparatus 24 (the smart device 20 is used as an example in the following description).

In this case, guidance information 90, which is described below, is displayed in the smart device 20 of the user and announced if desired (the same is true below).

Guidance information 90: “I recommend setting a lower charging target value in order to prolong the battery life. Would you like to use this function? YES, NO”. Here, the “charging target value” is the target SOC.

When Option a (YES) is selected by the user, at the timing t3, guidance information 91 described below is displayed. In other words, the user is prompted to input an initial target SOC (initial target value).

Guidance information 91: “Please set an initial target value. **%”.

Between the timings t3 and t4, after the battery 30 has been charged, the electric vehicle 10 is used for commuting or the like. As an example, the electric vehicle 10 driven by the user departs from the prescribed parking location near the charging equipment 14 at 8:00 AM and returns to the prescribed parking location at 6:00 PM.

At the timing t4, a state in which charging can be started is detected due to the charging plug 32 being attached to the charging port 36. From this timing t4 until the timing t5 at which the charging plug 32 is removed from the charging port 36 and the end of charging is detected, the battery 30 of the electric vehicle 10 is charged by the charging equipment 14. In this case, the charging is performed up to the initial target SOC if the initial target SOC has been set. If an initial target SOC has not been set, the charging is performed until a measured value of a remaining capacity meter (not shown in the drawings) reaches 100[%] (in actuality, a default setting value between 70[%] and 80[%] for the SOC corresponding to the battery 30 to prevent full-charge deterioration of the battery 30. The same is true below).

During the initial charging after the setting between the timings t4 and t5, guidance for reducing the target SOC according to guidance information 92 described below is not performed.

The charging is finished, and the electric vehicle 10 is then used again between the timings t5 and t6.

When the state in which charging can be started is detected again at the timing t6, the guidance information 92 described below is displayed on the smart device 20 at the timing t7, which is before the timing t8 at which the charging of the electric vehicle 10 starts. The intent to reduce the target SOC can be confirmed with the user through this guidance information 92.

Guidance information 92: “The remaining capacity was *[%] when charging was started this time. The battery lifetime can be prolonged by using a lower remaining capacity. Would you like to set the target value for charging this time to be 5[%] lower than the previous time (**[%])? YES/No change this time/Keep using the previous value”.

In this case, if permission from the user (Option a-1: YES_ use the target SOC reducing function and agree to the reduction amount of the system) is input for this guidance information 92, the target SOC is reduced by a certain amount, which is 5[%] in this case.

If “No change this time” (Option a-2) is selected (input), the guidance information 92 is displayed again the next time that the vehicle is charged.

It should be noted that, if “No change this time” (Option a-2) is selected (input), it is conceivable that the user might not want to use the target SOC reducing function due to having a long trip planned, for example, and therefore this is judged as Option c. In such a case, the user is notified that the charging will be performed until the measured value of the remaining capacity meter reaches 100[%], as the charging target value.

If “Keep using the previous value” (Option a-3) is selected (input), the guidance information 92 is not displayed next time the vehicle charging is performed. However, from the timing t9 onward, the guidance information 92 is displayed and the user is recommended to use the target SOC reduction function during the vehicle charging performed several times later.

### [Detailed Operation]

The following describes the details of the operation performed by the (CPU of the) charging control apparatus 22 of the system 12, while referencing the flowchart (1/2) of FIG. 4 and the flowchart (2/2) of FIG. 5.

The subject executing the program according to these flow charts is the charging control apparatus 22 (any one of the judging section 42, implementing section 44, and notifying section 46, excluding the storage section 40).

At step S1, a judgment is made concerning whether it is the initial usage timing (timing t1 in FIG. 3).

If it is the initial usage timing (step S1: YES), at step S2, the user is presented with a choice concerning whether or not a function is to be used. In other words, at the timing t2, the guidance information 90 (FIG. 3) is displayed on the smart device 20.

At step S3, a judgment is made concerning whether the user intends to use the target SOC reducing function (upper-limit limiting function).

If NO (Option b) is selected (step S3: YES), there is no intent to use the function, and at step S4, the target SOC is set equal to 100[%].

On the other hand, at step S3, if NO (Option a) is selected (step S3: NO), there is intent to use the function, and at step S5, notification prompting the input of a setting for the initial target SOC {guidance information 91 (FIG. 3)} is displayed on the smart device 20.

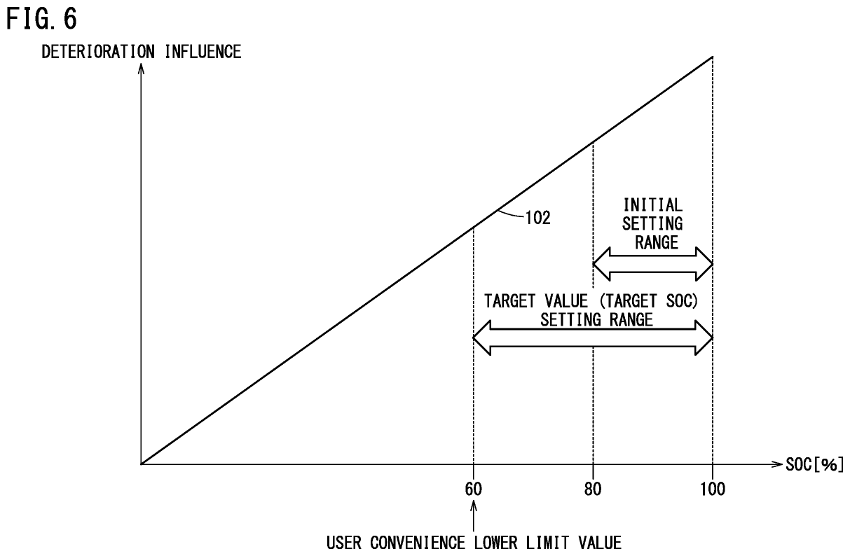

In this case, as shown in FIG. 6, a deterioration influence characteristic 102 (battery characteristic), an initial setting range, and a target value (target SOC) setting range are displayed on the smart device 20. The deterioration influence characteristic 102 of the battery 30 loaded in the present embodiment indicates a tendency for the deterioration to progress more the greater the SOC. The deterioration influence characteristic 102 differs according to the specifications of the battery 30. An example of a setting for a battery 30 having a different deterioration influence characteristic 102 is described further below as a “third modification”.

A lower limit value of the target value setting range is set to a user convenience lower limit value according to the deterioration influence characteristic 102.

The user sets a value in the initial setting range, using the smart device 20.

When the charging control apparatus 22 receives the initial setting value at step S6, at step S7, the target SOC is set to the initial setting value.

Next, when the charging plug 32 is attached to the charging port 36, at step S8, the start of charging is detected (timing t3).

In this case, at step S9, the battery 30 is charged to SOC=100[%] or to the value in the initial setting range set by the user, within the target value setting range.

At step S10, the charging ends, and here, the removal of the charging plug 32 from the charging port 36 is detected.

Next, the process returns to step S1, proceeds to step S1: NO, and enters a standby state waiting for the charging start detection (timing t6) of step S11.

At step S11, when a new charging-start-capable state is detected (timing t6), at step S12, the guidance information 90 (FIG. 3) is again displayed to the user who has already set at step S3 that there is no intent to use the function.

If NO (Option b) is selected for the guidance information 90 (step S12: YES), there is no intent to use the function, and at step S13, the target SOC is set equal to 100[%]. In this case, the processing from step S9 onward is performed.

At step S12, the guidance information 92 (FIG. 3) is displays to the user who has already set that there is intent to use the function at step S3 (step S12: NO).

In this case, at step S14, if “No change this time” (Option c) is selected, that is, if the target SOC reducing function is to be used but the target SOC reducing function is stopped just for the charging this time (step S14: YES), at step S13, the target SOC is set equal to 100[%].

On the other hand, at step S14, if there is no intent to temporarily revoke the function (step S14: NO), the process moves to step S15 in FIG. 5.

At step S15, if the continuing target SOC has already been set (step S15: YES), at step S16, the target SOC is set to the continuing SOC, and the processing from step S9 onward is performed.

At step S15, if the continuing target SOC is not set (step S15: NO), at step S17, a judgment is made concerning whether the SOC at the charging start timing is less than or equal to an announcement judgment threshold value, which is described below.

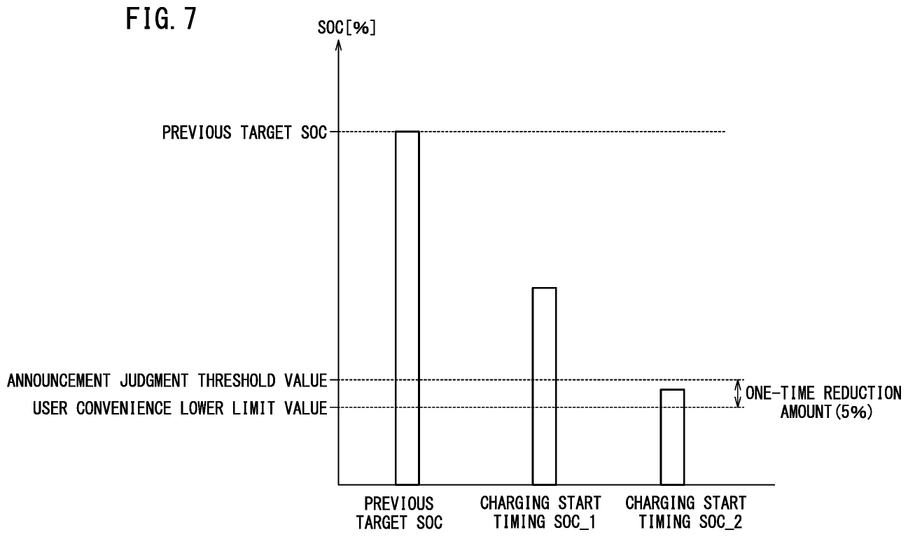

As shown in FIG. 7, the announcement judgment value is set to be a value that is larger than the user convenience lower limit value (see also FIG. 6) by a one-time reduction amount (5[%]) added thereto.

In this case, if the charging target value reduction guidance (guidance information 92 shown in FIG. 3, which is the charging target value reduction announcement) is performed excessively, there is a concern that the user will feel irritated.

In order to avoid this, if the SOC at the charging start timing is less than the announcement judgment threshold value (e.g. the charging start timing SOC_2 in FIG. 7), which is the threshold value beyond which the target SOC should not be reduced, since it was judged that the previous target SOC is suitable, the user is notified that the previous target SOC has been set as the continuing target SOC.

In other words, if the SOC at the charging start timing is less than or equal to the lower limit value of the announcement judgement threshold value (user convenience lower limit value) (step S17: YES), the user convenience would be impaired if the target SOC were to be lowered below this value, and therefore the previous target SOC is treated as being suitable, the continuing target SOC is set to be the previous target SOC at step S18, and notification that the target SOC continuing to be set is the previous target SOC is provided to the smart device 20 of the user at step S19.

In this case, at step S16, the target SOC is set to be the continuing target SOC (previous target SOC), and the charging process from step S9 onward is performed.

On the other hand, at step S17, if the SOC at the charging start timing exceeds the announcement judgment threshold value (step S17: NO), at step S20, the intent of the user regarding reduction (Option a-1, a-2, or a-3) according to the answer to the guidance information 92 in step S12 is confirmed.

At step S21, if the user has indicated intent to fix the target SOC at the current setting value (step S21: YES), that is, for a user who has selected “Keep using the previous value (Option a-3)” in response to the guidance information 92 in step S12, the processes of step S18 (setting the previously set target SOC as the continuing target SOC), step S19 (notifying (presenting to) the user that the continuing target SOC is the previous target SOC), step S16 (instructing the implementing section 44 that the target SOC is to be the continuing target SOC), and step S9 (the implementing section 44 charging up to the target SOC) described above are performed.

In this way, the processing is performed in the order of steps S20→S21→S18→S19→S16→S9 for a user who has selected Option a-3, that is, as user who uses the previously set target SOC as the continuing target SOC.

The following describes a case in which, at step S21, the user does not intend to fix the target SOC that is the current setting value (step S21: NO). In other words, it is judged at step S22 that reduction of the target SOC is desired (step S22: YES) by a user who has selected “YES (Option a-1) in response to the display of the guidance information 92 at step S12 (in other words, a user who uses the target SOC reduction function and agrees with the reduction amount of the system). In this case, at step S23, the target SOC at the time of the current charging is set to a value obtained by subtracting the one-time reduction amount (5[%]) from the target SOC at the time of the previous charging (current target SOC=previous target SOC−one-time reduction amount). After this, the charging process from step S9 onward is implemented.

In this way, for a user who has selected “Option a-1: Use (YES)”, that is, a user who uses the target SOC reduction function and agrees to the reduction amount of the system, the processing is performed in the order of steps S20→S21 (NO)→S22 (YES)→S23→S9.

At step S22, the process of step S24 is implemented for a user who has selected “No change this time (Option a-2)” in response to the display of the guidance information 92 in step S12 {in other words, a user who uses the target SOC reducing function but does not agree (disagrees) with the reduction amount of the system this time}. At step S24, the target SOC is set to the previous SOC stored in the storage section 40. After this, the charging process from step S9 onward is implemented.

In this way, for the user who has selected “Option a-2: No change this time” {in other words, the user who uses the target SOC reducing function but does not agree (disagrees) with the reduction amount of the system this time}, the processing is performed in the order of steps S20→S21(NO)→S22(NO)→S24→S9.

As described above, for a user who has selected “Option b; Do not use” in the guidance information 90 (in other words, a user who does not use the target SOC reducing function), the processing is performed in the order of steps S3(YES)→S4→S8→S9.

Furthermore, for a user who has selected “Option c: No change this time” in the guidance information 92 (in other words, a user who uses the target SOC reducing function but stops the target SOC reducing function just for the charging this time), the processing is performed in the order of steps S12(NO)→S14(YES)→S13→S9.

### [Modifications]

The embodiment described above can be modified in the manner described below.

### [First Modification]

FIG. 8 is a system diagram showing a configurational example of a system 12A in which a portion of a charging control apparatus 22A is implemented in a management server 82 on the Internet, through the communication network 16.

The implementing section 44 is implemented in an electric vehicle 10A as a remaining portion of the charging control apparatus 22A. On the other hand, a storage section 40A, a judging section 42A, and a notifying section 46A, excluding the implementing section 44, are implemented as the charging control apparatus 22A of the management server 82.

In the system 12A of FIG. 8, the electric vehicle 10A includes the communication control unit 25, and the communication control unit 25 transmits and receives data to and from the management server 82 wirelessly via the communication network 16.

The management server 82 gathers various types of vehicle information (including information concerning each piece of charging equipment 14 connected to each electric vehicle 10A) from a plurality of electric vehicles 10A, via the communication network 16, and accumulates this information in a storage section 40A that is a database.

When the battery 30 of the electric vehicle 10A needs to be charged, the management server 82 notifies the smart device 20 of the owner of the electric vehicle 10A of this fact via the communication network 16 (Internet). In this case, a text reading “Please charge your car” is displayed in the display section of the smart device 20.

In the system 12 of FIG. 1 as well, when the battery 30 needs to be charged, the smart device 20 is notified of this fact from the communication control unit 25 via the communication network 16.

In the system 12A of FIG. 8, the storage section 40A, the judging section 42A, and the notifying section 46A are implemented in the management server 82 connected to the communication network 16, and the implementing section 44 is implemented in the navigation apparatus 24A. The implementing section 44 may also be implemented in the management server 82.

The storage section 40A, the judging section 42A, and the notifying section 46A have the same configurations and effects as the storage section 40, the judging section 42, and the notifying section 46 of FIG. 1. The following describes the differing points between the embodiment of FIG. 1 and the first modification of FIG. 8. The storage section 40, the judging section 42, and the notifying section 46 of the electric vehicle 10 shown in FIG. 1 are involved with charging control for only the electric vehicle 10. In contrast to this, the storage section 40A, the judging section 42A, and the notifying section 46A of the management server 82 shown in FIG. 8 are involved with charging control for a plurality of electric vehicles 10A.

The configurations and effects of portions in which the storage section 40A, the judging section 42A, and the notifying section 46A of the management server 82 that are involved independently with the battery 30 of each electric vehicle 10A are the same as the effects of the storage section 40, the judging section 42, and the notifying section 46 of the electric vehicle 10 shown in FIG. 1.

In other words, the storage section 40A of the management server 82 gathers a usage history of each electric vehicle 10A via the communication network 16 from the plurality of electric vehicles 10A, and accumulates this usage history in the management server 82 for each electric vehicle 10A.

The judging section 42A detects the end of the charging of the electric vehicle 10A, and performs the target SOC setting process according to the flow charts of FIGS. 4 and 5 for each electric vehicle 10A.

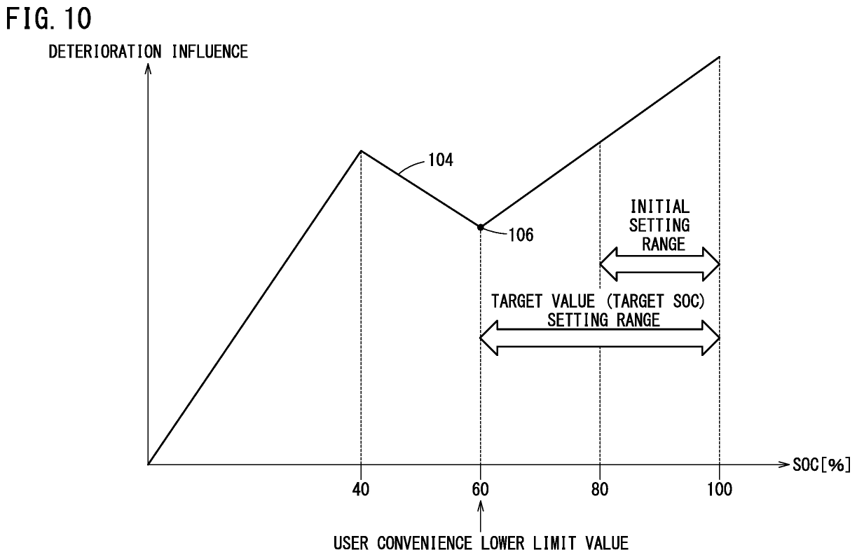

Information such as the deterioration influence characteristic 102 and the deterioration influence characteristic 104 (FIG. 10) of each electric vehicle 10A is transmitted to the implementing section 44 of each electric vehicle 10A via the communication network 16.

The implementing section 44 of each electric vehicle 10A has the same configuration and effect as the implementing section 44 of the electric vehicle 10 in FIG. 1. The differing point is that, while the implementing section 44 of the electric vehicle 10 in FIG. 1 has the target SOC setting performed by the judging section 42 in the vehicle without passing through the communication control unit 25, the target SOC setting is performed by the management server 82 in the modification of FIG. 8.

The implementing section 44 of each electric vehicle 10A for which charging control is performed by the management server 82, upon receiving instructions for setting the target SOC of the battery 30 from the judging section 42A via the communication network 16, charges the battery 30 up to the remaining capacity (target SOC) indicated by the instructions from the judging section 42A.

### [Second Modification]

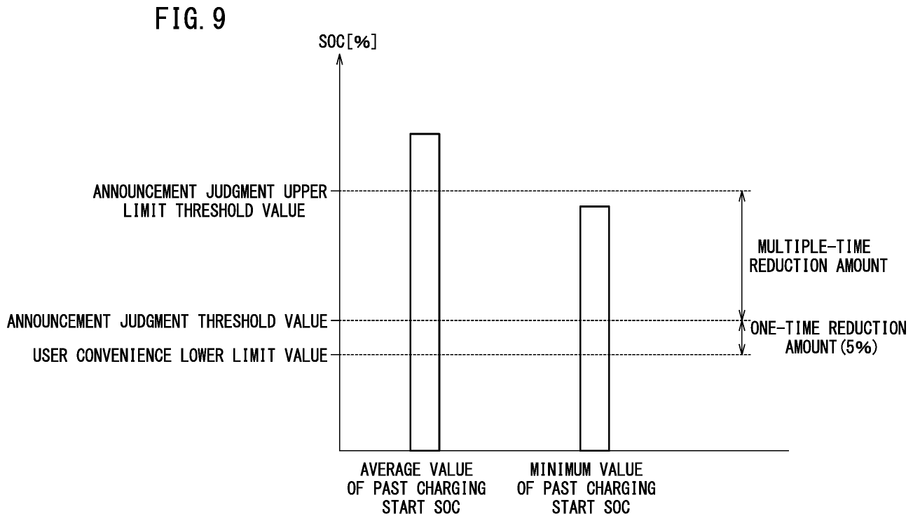

A function utilization recommending operation of the notification system (function activation recommending of the notification system) that provides notification recommending lowering of the target SOC is described while referencing FIG. 9.

The process according to the flow charts of FIGS. 4 and 5 is implemented at step S10 when a subsequent charging is started after the detection of the end of a charging.

The function utilization recommending operation is implemented in a case where usage of the function is continually stopped {a case where step S3 is affirmative (step S3: YES) a prescribed number of times} and the SOC at the charging start timing stays at high values each time.

Alternatively, the function utilization recommending operation is implemented in a case where the target SOC is continually fixed at a high position {a case where the continuing target SOC at step S16 (FIG. 5) is a high value} and the SOC at the charging start timing stays at high values each time.

In these cases, it can be expected that there is little chance of the user convenience being impaired even if a lower value is set for the target SOC and that the lifetime of the battery 30 can be extended.

When such a situation is detected, a user who is not utilizing the function is encouraged to utilize the function, and a proposal for again reducing the target SOC is made to a user who has fixed the target SOC at a high value.

The standard for the recommendation judgment in this case is to observe the charging start SOC each time from when the user stops utilizing the function or fixes the target SOC.

A determination is made to make another recommendation only when the minimum value of the charging start SOC during the observation is greater than the announcement judgment threshold value of FIG. 9 (first judgment threshold value) and the average value of charging start SOC in the past is greater than the announcement judgment upper limit value (a second judgment threshold value that is greater than the first judgment threshold value).

### [Third Modification]

The target SOC setting process and target SOC reducing process corresponding to the deterioration influence characteristic 104, which is a battery characteristic of the battery 30, are described while referencing FIG. 10.

There is a minimal point 106 of deterioration influence in the deterioration influence characteristic 104. This minimal point is a point at which the deterioration influence switches from a decreasing trend to an increasing trend relative to an increase of the SOC.

With such a deterioration influence characteristic 104, when the target SOC is set to be less than or equal to the minimal point 106, there is a possibility that use by the user tending toward promoting deterioration will be induced over most of the range.

Therefore, in an electric vehicle 10 or 10A in which a battery 30 having such a deterioration influence characteristic 104 is loaded, the target SOC setting range is set to be from the minimal point 106 to 100[%].

The user may be worried that the SOC (remaining capacity) may be exhausted while the electric vehicle 10 is running.

To restrict deterioration of the battery 30, the minimal point 106 is set to the user convenience lower limit value so that the target SOC becomes the minimal point 106.

In order to cause the user to set the target SOC to the user convenience lower limit value, it is important for the user to feel through experience that there are no problems with the normal usability even when the target SOC is set low.

Therefore, as shown in FIG. 10, it is possible to realize a user experience that gradually leads to a region where the target SOC is low due to this reducing function, by limiting the range in which the target SOC can be set initially to a region in which the target SOC is somewhat high.

[Invention Understandable from the Embodiment and Modifications]

The invention that can be understood from the embodiment and first to third modifications described above is recorded below. The reference numerals used above are affixed to configurational elements to facilitate understanding, and these configurational elements are not limited to the components given these reference numerals.

A charging control method of an electric moving body that moves using a battery 30 as a power source includes setting a target remaining capacity through a user when initial charging of the battery is performed; and setting the target remaining capacity in a manner to decrease every time the battery is charged, based on a usage situation of the battery of the electric moving body by the user.

With this configuration, the target remaining capacity is set through the user when the battery of the electric moving body is initially charged, and from this time onward the target remaining capacity is set in a manner to decrease every time charging is repeated at a first charging, at a second charging, and so on based on the usage situation of the battery of the electric moving body by the user.

Due to this, revocation of the setting of the target remaining capacity is restricted while eliminating the worry felt by the user about insufficient remaining capacity, and it is also possible to avoid an overcharge state and restrict deterioration of the battery.

In the charging control method of the electric moving body, when setting the target remaining capacity to decrease, the user is notified that the target remaining capacity decreases, and when providing this notification, notification is provided if the remaining capacity at a charging start timing is greater than or equal to a threshold value set based on a discharge amount of a following usage schedule from the usage situation, and notification is not provided and the target remaining amount is not decreased if the remaining capacity at the charging start timing is less than the threshold value.

Due to this, since the target remaining capacity is set to decrease when the remaining capacity at a charging start timing is greater than or equal to a threshold value set based on a discharge amount of a following usage schedule from the usage situation of the battery of the electric moving body by the user, it is possible to reduce the target remaining capacity after the user has agreed to the lowering, and therefore it is possible to avoid an overcharge state and restrict deterioration of the battery, ensuring that the user does not feel anxiety about a power shortage.

In the charging control method of the electric moving body, a characteristic of a deterioration degree relative to the remaining capacity of the battery may be acquired in advance, before the target remaining capacity at the initial charging timing is set; a minimal point, at which the deterioration degree switches from decreasing to increasing in response to an increase of the remaining capacity, may be acquired from the acquired deterioration degree characteristic; and the target remaining capacity after the setting may be set in a manner to not drop below a remaining capacity at the minimal point.

Due to this, the target remaining capacity of the battery is set to not drop below the remaining capacity at the minimal point, and therefore it is possible to set a suitable target remaining capacity enabling restriction of the deterioration of the battery.

In the charging control method of the electric moving body, in a case where the target remaining capacity is set to decrease and even though it is possible to use a notification system that notifies the user that the target remaining capacity is decreased, the user has not activated a function of the notification system, the remaining capacity at the charging start timing may be observed continuously a plurality of times; and when a minimum value of the observed remaining capacity at the charging start timing is greater than a first judgement threshold value, at which it is possible to decrease the target remaining capacity by a certain amount at least one time, a recommendation may be made to the user to activate the function of the notification system.

Due to this, in a case where even though it is possible to use the notification system that notifies the user that the target remaining capacity is decreased, the user has not activated a function of the notification system, the remaining capacity at the charging start timing is observed continuously a plurality of times, and when the minimum value of the observed remaining capacity at the charging start timing is greater than the first judgement threshold value, at which it is possible to decrease the target remaining capacity by a certain amount at least one time, the recommendation is made to the user to activate the function of the notification system, and therefore it is possible to suitably present the user with an opportunity to restrict deterioration of the battery according to the usage situation of the user.

In the charging control method of the electric moving body, when the recommendation is made to the user to activate the function of the notification system while the minimum value of the observed remaining capacity at the charging start timing is greater than the first judgement threshold value, at which it is possible to decrease the target remaining capacity by the certain amount at least one time, a recommendation may be made to the user to activate the function of the notification system if the minimum value of the observed remaining capacity at the charging start timing is greater than the first judgment threshold value and an average value of the observed remaining capacity at the charging start timing is greater than a second judgement threshold value that is greater than the first judgment threshold value.

Due to this, the possibility of being able to decrease the target remaining capacity by the certain amount a plurality of times is increased, and therefore the convenience for the user using the notification system is improved.

An electric moving body comprises a charging control apparatus 22 or 22A of the electric moving body that moves using a battery as a power source, wherein the charging control apparatus includes a memory that stores a program and a CPU that reads the program from the memory and executes the program; the CPU executing the program causes the charging control apparatus to set a target remaining capacity through a user when initial charging of the battery is performed; and to set the target remaining capacity to decrease every time the battery is charged, based on a usage situation of the battery of the electric moving body by the user.

According to this invention, the target remaining capacity is set through the user when the battery of the electric moving body is initially charged, and from this time onward the target remaining capacity is set in a manner to decrease every time charging is repeated at a first charging, at a second charging, and so on based on the usage situation of the battery of the electric moving body by the user.

Due to this, revocation of the setting of the target remaining capacity is restricted while eliminating the worry felt by the user about insufficient remaining capacity, and it is also possible to avoid an overcharge state and restrict deterioration of the battery.

The present invention is not limited to the embodiment described above, and it is obvious that various configurations can be adopted based on the content recorded in this Specification.

What is claimed is:

1. A charging control method of an electric moving body that moves using a battery as a power source, comprising:
setting a target remaining capacity through a user when initial charging of the battery is performed; and
setting the target remaining capacity in a manner to decrease every time the battery is charged, based on a usage situation of the battery of the electric moving body by the user.

2. The charging control method of the electric moving body according to claim 1, wherein:
when setting the target remaining capacity to decrease, the user is notified that the target remaining capacity decreases, and when providing this notification, notification is provided if the remaining capacity at a charging start timing is greater than or equal to a threshold value set based on a discharge amount of a following usage schedule from the usage situation, and notification is not provided and the target remaining amount is not decreased if the remaining capacity at the charging start timing is less than the threshold value.

3. The charging control method of the electric moving body according to claim 1, wherein:
a characteristic of a deterioration degree relative to the remaining capacity of the battery is acquired in advance, before the target remaining capacity at the initial charging timing is set;
a minimal point, at which the deterioration degree switches from decreasing to increasing in response to an increase of the remaining capacity, is acquired from the acquired deterioration degree characteristic; and
the target remaining capacity after the setting is set in a manner to not drop below a remaining capacity at the minimal point.

4. The charging control method of the electric moving body according to claim 2, wherein:
a characteristic of a deterioration degree relative to the remaining capacity of the battery is acquired in advance, before the target remaining capacity at the initial charging timing is set;
a minimal point, at which the deterioration degree switches from decreasing to increasing in response to an increase of the remaining capacity, is acquired from the acquired deterioration degree characteristic; and
the target remaining capacity after the setting is set in a manner to not drop below a remaining capacity at the minimal point.

5. The charging control method of the electric moving body according to claim 1, wherein:
in case where the target remaining capacity is set to decrease and even though it is possible to use a notification system that notifies the user that the target remaining capacity is decreased, the user has not activated a function of the notification system, the remaining capacity at the charging start timing is observed continuously a plurality of times; and
when a minimum value of the observed remaining capacity at the charging start timing is greater than a first judgement threshold value, at which it is possible to decrease the target remaining capacity by a certain amount at least one time, a recommendation is made to the user to activate the function of the notification system.

6. The charging control method of the electric moving body according to claim 5, wherein:
when the recommendation is made to the user to activate the function of the notification system while the minimum value of the observed remaining capacity at the charging start timing is greater than the first judgement threshold value, at which it is possible to decrease the target remaining capacity by the certain amount at least one time, a recommendation is made to the user to activate the function of the notification system if the minimum value of the observed remaining capacity at the charging start timing is greater than the first judgment threshold value and an average value of the observed remaining capacity at the charging start timing is greater than a second judgement threshold value that is greater than the first judgment threshold value.

7. An electric moving body comprising a charging control apparatus of the electric moving body that moves using a battery as a power source, wherein:
the charging control apparatus includes a memory that stores a program and a central processing unit that reads the program from the memory and executes the program;
the central processing unit executing the program causes the charging control apparatus to set a target remaining capacity through a user when initial charging of the battery is performed; and
to set the target remaining capacity to decrease every time the battery is charged, based on a usage situation of the battery of the electric moving body by the user.
